(19) United States
(12) Patent Application Publication
(10) Pub. No.: US 2002/0108068 A1
(43) Pub. Date: Aug. 8, 2002

(54) Power management for digital processing apparatus

(76) Inventor: Martinus Jacobus Coenen, Eindhoven (NL)

Correspondence Address: Michael E. Marion, c/o U.S. PHILIPS CORPORATION, Intellectual Property Department, 580 White Plains Road, Tarrytown, NY, 10591, US

(21) Appl. No.: 10/042,464

(22) Filed: Jan. 8, 2002

(30) Foreign Application Priority Data
Jan. 11, 2001 (EP) 01200084.0

(51) Int. Cl. G06F 1/26; G06F 1/28; G06F 1/30

(52) U.S. Cl. 713/322

(57) ABSTRACT

In order to provide a gradual increase in supply current following an apparatus switch-on, the invention proposes a device and method for selectively activating different data processing parts of the apparatus in sequence following switch-on. The device proposed for implementing the invention comprises a shift register (10) and logic circuitry (20). The shift register (10) and logic circuitry (20) receive a common master clock CLK and generate a plurality of sub-clocking signals CLK₀-CLK₃ which, whilst being identical in frequency and in phase with one another, are arranged to only assume a normal free running condition, one at a time following the initial switch-on. The respective sub-clocking signals are connected to clock inputs of respective data processing parts of the apparatus. Providing such separate sub-clocking signals ensure a gradual start-up and shut-down and helps to avoid problems associated with a heavy current draw at switch-on or off.

The invention relates to a device and method for power management for a digital processing apparatus.

The use of clocked mode digital logic integrated circuits, in particular microprocessors, is commonplace in a wide variety of goods. It is desirable to reduce the power needed by such circuits, since this reduces the energy costs involved in operating the goods in which they are installed. In addition, excessive power dissipation with a circuit may cause a temperature rise that could shorten the life-span of the circuit. To reduce these problems, circuits have been devised in which certain parts are “turned off” when not in use. In clocked mode digital logic circuits, the turning off state can be achieved by not supplying a clock signal to those parts of the circuit, which are not required a given time. Since the current (and therefore power) drawn by clocked digital circuits is a function of clock speed, and the clock speed of such circuits is increasing as technology advances, the ability to turn off the parts of a circuit which are not required is becoming more advantageous. Turning large parts of the circuit on and off is not without problems; most important of which is the step variation in current the power supply has to provide as all the elements of that part of the circuit switch on or off simultaneously.

A number of solutions exist to aid the transition between low current supply and high current supply. These include a dummy load resistance is provided in parallel with the circuit to be turned on or off. The dummy resistance varies to gradually increase the power drawn from the source up to the power needed by external additional circuitry, at which point the circuitry is switched on and the dummy resistance removed. This scheme is applied in reverse when the circuitry is switched off and described in U.S Pat. No. 5,646,572 (IBM). Alternatively, as described in U.S. Pat. No. 5,964,881 (AMD) the rate of the clock can be slowed at switch on to reduce the power needed by the additional circuitry then increased gradually over a number of clock cycles to bring the circuit up to operating speed. This scheme can also be applied in reverse when the circuitry is switched off. Until the clock speed has synchronized, no signal processing is possible.

Both the above-mentioned schemes require complex additional circuitry.

In addition to any provisions outlined above or otherwise, on-chip capacitors are needed to decouple power supply bounce and ground bounce and absorb the transient current demands produced by the switching on or off of clocked mode digital circuits. In the case of integrated circuits such capacitors may be fabricated on the chip, which is expensive and consumes large dye areas. Alternatively, off-chip capacitors may be used, but these are not as effective and also necessitate extra manufacturing steps. Off-chip decoupling results in supply currents through the IC package that will therefore contribute to RF radiation. It is therefore advantageous to minimize the off-chip capacitance required to absorb the transient current demands by reducing the transients, but without introducing additional complex circuitry or otherwise seriously compromising the operation of the circuit as a whole.

It is an object of embodiments of the present invention to provide a method and device for reducing the step change in current required from a power supply as a clocked digital circuit switches on or off which overcomes some of the problems associated with the prior art, whether referred to herein or otherwise. To this end, the invention provides a power management as defined in the independent claims. Advantageous embodiments are defined in the dependent claims.

According to a first aspect of the present invention, there is provided a method of power management in a digital processing apparatus, the method comprising: receiving a free-running master clock signal; and from said master clock signal generating a plurality of sub-clocking signals, wherein said plurality of sub-clocking signals change from a power-up rest condition to a free running condition one at a time, following an initial switch-on of said digital processing apparatus.

According to a second aspect of the invention, there is provided a device for power management for a digital processing apparatus, the device comprising: means for receiving a free running master clock signal and generating a plurality of sub-clocking signals, wherein said plurality of sub-clocking signals change from a power-up rest condition to a free running condition one at a time, following an initial switch-on of said digital processing apparatus.

The device and method provide a convenient way of gradually starting up apparatus and thereby controlling supply current at switch-on.

Clocking data parts with separately generated clocks as set out in claim 3 provides a controlled increase in supply demand following switch-on and enables prioritization of order of activation of data parts either based on power requirements or importance.

Each data processing part may comprise circuitry for processing a particular data bit or bits of a data word—particularly useful where the processing apparatus has a pipeline arrangement.

Said digital signal processing apparatus has a particular maximum data width and conveniently said plurality of sub-clocking signals may correspond to said maximum data width.

In certain embodiments said plurality of sub-clocking signals may, during a switch-off phase change from a free running condition to a rest condition one at a time. By employing such a “soft” switch-off, undesirable transient effects may be avoided.

For a better understanding of the invention, and to show how embodiments of the same may be carried into effect, reference will now be made, by way of example, to the accompanying diagrammatic drawings in which:

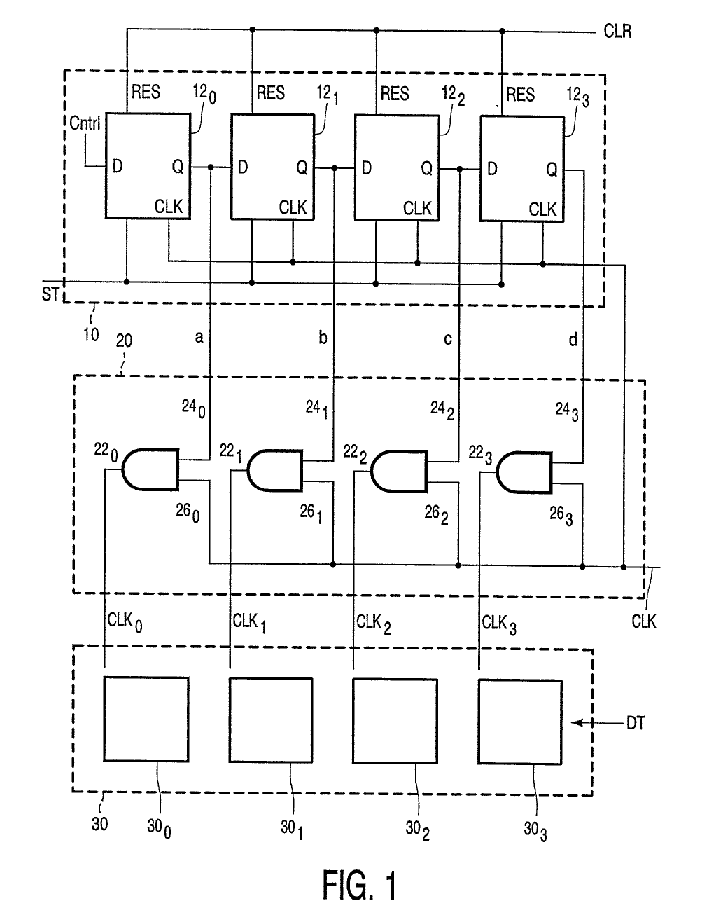

FIG. 1 is a schematic circuit diagram of an embodiment of the present invention; and

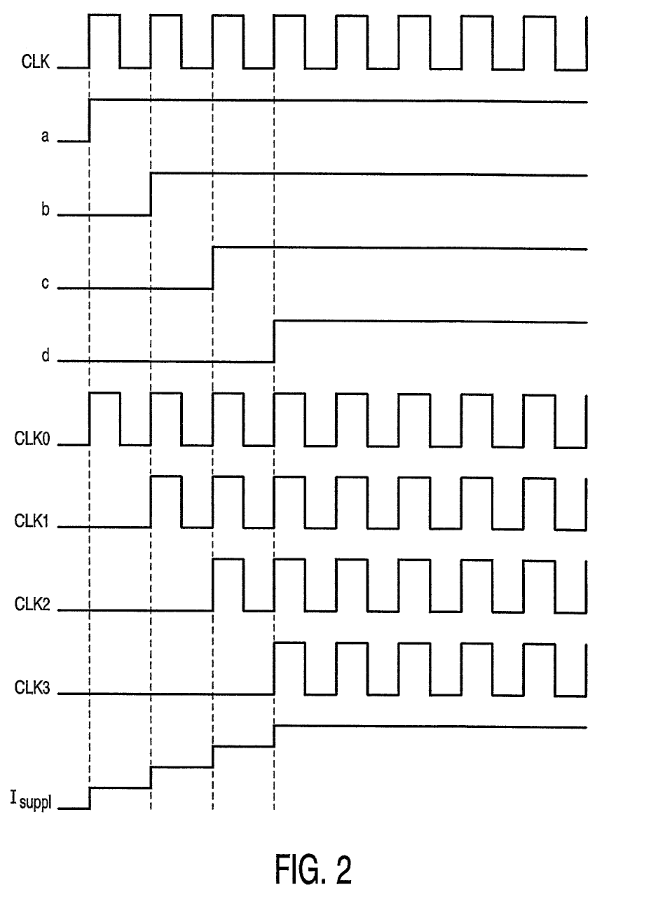

FIG. 2 is a timing diagram for the FIG. 1 circuit.

Referring now to FIG. 1, there is shown an example of a device embodying the present invention. The device comprises a shift register 10 and logic circuitry 20. There is also shown in schematic format digital processing apparatus 30 that is to be managed by the device.

The shift register 10 comprises a plurality of interconnected flip-flops 12₀, 12₁, 12₂, 12₃. Where the digital processing apparatus to be controlled is a pipeline arrangement, the number of flip-flops supplied is determined by the pipeline depth. Each flip-flop 12₀, 12₁, 12₂, 12₃ has a number of connections comprising clock input CLK, data input D, data output Q, a set input ST and a clear input RES.

The data input D of the first flip-flop 12₀ is connected to a control signal Cntrl. The data output Q of the first flip-flop 12₀ is connected firstly to the data input D of the second flip-flop 12₁, but also to provide a first enable signal a to the logic circuit 20. The second flip-flop 12₁ has its data output Q connected to the data input D of the third flip-flop 12₂ and also provides a second enable signal b to the logic circuit 20. The third flip-flop 12₂ has its data output Q connected to the data input D of the fourth flip-flop 12₃ and also provides a third enable signal c to the logic circuit 20. The fourth flip-flop 12₃ has its data output Q connected to the logic circuit 20 so as to provide it with a fourth enable signal d.

The flip-flops 12₀, 12₁, 12₂, 12₃ are connected via their respective reset inputs RES to a common clear line CLR and are also commonly clocked via their respective clock inputs CLK.

The logic circuit 20 comprises a plurality of AND gates 22₀, 22₁, 22₂ and 22₃. Each AND gate 22₀, 22₁, 22₂, 22₃ has a first input 24₀, 24₁, 24₂, 24₃ and a second input 26₀, 26₁, 26₂, 26₃ and an output CLK₀, CLK₁, CLK₂, CLK₃. The first inputs 24₀, 24₁, 24₂, 24₃ of the AND gates 22₀, 22₁, 22₂, 22₃ are connected, respectively, to receive the first to fourth enable signals a, b, c, d. The second inputs input 26₀, 26₁, 26₂, 26₃ of the AND gates 22₀, 22₁, 22₂, 22₃ are commonly connected to clock line CLK. The outputs CLK₀, CLK₁, CLK₂ CLK₃ are output to the digital processing apparatus 30, to form sub-clocks of individual data processing parts 30₁-30₃ that receive data DT.

The operation of the circuit of FIG. 1 will now be described with reference to the timing diagrams of FIG. 2 which shows a master clock signal CLK, and timings relative to the master clock CLK for the enable signals a, b, c, d, output sub-clocking signals CLK₀, CLK₁, CLK₂, and CLK₃ and a supply current Iₛᵤₚₚₗ.

Referring now to FIG. 1, an initial state of the shift register 10 will be considered.

At power up of the system, a power on reset function sends a signal via the clear line CLR to reset terminals RES of the individual flip-flops 12₀ to 12₃ of the shift register 10, so as to initially load the shift register 10 with logical 0's.

The reset function is used during start-up. During power-up, the reset line CLR is kept low, to ensure a non-operative circuit, i.e. a low supply current, by clearing the outputs of all flip-flops. In this way, none of the circuits normally driven by the clock receive a clock signal. Thereafter, when data processing is required, a control device is arranged to set the data input D of the first flip-flop 12₀ to be a logic high.

According to the timing diagram, when the first clock pulse after the power on reset is applied to the CLK inputs of the flip-flops 12₀ to 12₃, the logical 1 at the D input of flip-flop 12₀ is clocked through to the output Q so as to send signal a high. It will be evident that as subsequent clock pulses are input to the CLK terminals of the flip-flops 12₀ to 12₃ of the shift register 10, the register will, in four cycles of the clock, change the states of the respective flip-flops 12₀ to 12₃ from 0000 to 1000 to 1100 to 1110 to 1111. Thereafter, the shift register 10 will be full of logic 1's during the normal subsequent operations of the digital signal processing apparatus of which this circuit forms a part.

The outputs a, b, c, d of the shift register 10, as explained above, progress from a logic 0 state at initial turn-on of the apparatus to a logical 1, and then stay at that logic 1 state, the first signal a rising one clock cycle before the second signal b, which in turn rises one clock cycle before the third signal c, which in turn rises one clock cycle before the fourth signal d.

Enable signals a to d form validating inputs to AND gates 22₀ to 22₃ of the logic circuit 20.

The enable signals a to d are fed to the first inputs 24₀ to 24₃ of the AND gates 22₀ to 22₃, and the master clock signal CLK is fed to the second inputs 26₀ to 26₃.

Sub-clocking signals CLK₀-CLK₃ are produced by outputs of the AND gates 22₀ through 22₃ as shown in FIG. 2.

In the above fashion, it can be seen that a progressive loading of logic 1's through the register 10 ensures that proportionately with an applied signal to be processed by the controlled digital processing apparatus, a clock signal can be applied to the pipeline circuitry.

The circuitry as described above is of particular use when data is being processed in a serial fashion and when the order of the data bits proceeds in a predetermined manner. It is particularly of use in pipeline processing where a dedicated data processing part 30₁-30₃ of processing apparatus 30 is provided for each individual data bit of a data word. In such cases, individual processing parts 30₁-30₃ may, at switch on, receive individual respective clocking signals CLK₀ to CLK₃ such that a first bit of received data would have its processing part clocked by sub-clocking signal CLK₀, a second would have its clock signal provided by sub-clocking signal CLK₁, a third by sub-clocking signal CLK₂ and a fourth by sub-clocking signal CLK₃. In this manner, at turn on, the individual processing parts are effectively activated one at a time. In complex pipeline structures, there may be a significant power drain from each process stream as it is clocked and such sequential turn on enables the supply current Iₛᵤₚₚₗ of the overall apparatus to slowly ramp up to its full value. By allowing such slow ramping, the problems of the prior art are overcome or reduced to a certain extent.

It will be evident to the man skilled in the art that the circuitry may also be provided so as to provide a controlled turn off to the system so as to avoid any problems which might occur if the supply current were to suddenly be reduced. This may be achieved by maintaining the normal condition of each output of the register 10 being at logic 1 until all data desired to be processed has been done and thereafter loading the register progressively with logic 0's. In other words, when the last useful data has passed the data entry point of the pipeline, the control line Cntrl may be brought low and 0's fed into the register 10 to give a slow decay of supply current by stopping the sub-clocks CLK₁ through CLK₃ one at a time.

Also shown in FIG. 1 is a set line ST. This set function may be utilized by control circuitry to force a high output condition at each output of the register 10 simultaneously, so as to avoid the gradual system waking up period described. This set feature can be utilized when the digital processing apparatus in question needs to be tested and in such conditions a test may be carried out with the minimum of delay.

In a JTAG test mode instantaneous data processing can be carried out where various registers in the pipeline have data patterns fed into them and in which data is NOT clock serially.

It should be appreciated that under normal operation (i.e. beyond the start-up phase) of the digital processing apparatus the reset line CLR should never be used as it will cause all sub-clocks to shut down at once and therefore cause processing glitches.

It will also be evident that it may not be required that the sequential turn on or off of the sub-clocks is made in order of data bit receipt as, during turn on, there may be one or more data cycles in which the overall apparatus for which the circuitry of the present invention is intended, takes time to stabilize. Therefore, synchronizing the clocking signals with the arrival of data bits is not essential as sequential turn on of the different processing streams may therefore occur during a short wake up cycle of the apparatus, so that by the time valid data arrives all of the different data processing streams are receiving clock signals.

It will further be appreciated by the man skilled in the art that although a specific shift register layout and specific logic circuit layout has been shown, equivalents circuitry may replace those elements shown in the Figures. For instance, the logic circuitry may further include buffering elements, may be comprised of NAND gates or other processing logic, whereas the shift register may be configured differently to the layout shown in FIG. 1. It should thus be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of power management in a digital processing apparatus, the method comprising:
receiving a free-running master clock signal; and
generating a plurality of sub-clocking signals from said master clock signal, wherein said plurality of sub-clocking signals change from a power-up rest condition to a free running condition one at a time, following an initial switch-on of said digital processing apparatus (30).

2. A device for power management for a digital processing apparatus, the device comprising:
means (10, 20) for receiving a free running master clock signal; and
means (10, 20) for generating a plurality of sub-clocking signals from said master clock signal, wherein said plurality of sub-clocking signals change from a power-up rest condition to a free running condition one at a time, following an initial switch-on of said digital processing apparatus (30).

3. A device according to claim 2, wherein each sub-clocking signal is used to clock a separate data processing part (30₀-30₃) of said apparatus (30).

4. A device according to claim 3, wherein each data processing part (30₀-30₃) comprises circuitry for processing a particular serial data bit or bits of a data word.

5. A device according to claim 4, wherein said digital signal processing apparatus has a particular maximum data width and wherein said plurality of sub-clocking signals corresponds to said maximum data width.

6. A device according to claim 2, wherein during a switch-off phase of said digital processing apparatus, said plurality of sub-clocking signals change from a free running condition to a rest condition one at a time.

7. A device according to claim 2, wherein said means for receiving a master clocking signal and generating a plurality of sub-clocking signals comprise:
a shift register (10) for providing a plurality of enabling signals, said plurality of enabling signals each changing from a non-active rest condition to an active normal condition and thereafter remaining at said active normal condition, said plurality of enable signals changing from the rest condition to the normal condition one at a time at predetermined time intervals following the initial switch on; and
logic circuitry (20) for receiving the enable signals and sequentially enabling the production of the sub-clocking signals.

8. A device according to claim 7, wherein the logic circuitry (20) comprises means (22₀-22₃) for ANDing respective enable signals with the master clock.

9. A device according to claim 8, wherein the logic circuitry (20) comprises a number of AND gates (22₀-22₃) corresponding to the number of enable signals, each AND gate (22₀-22₃) having a first input (24₀-24₃) for receiving its respective enable signal and a second input (26₀-26₃) for receiving the master clocking signal, said sub-clocking signals being produced at the respective outputs of said AND gates.

10. Digital processing apparatus comprising:
a device in accordance with claim 2, and
a plurality of discrete data processing parts, each of said data processing parts being clocked by a respective one of said plurality of sub-clocking signals.
